(19) United States
(12) Patent Application Publication
(10) Pub. No.: US 2020/0225698 A1
(43) Pub. Date: Jul. 16, 2020

(54) DISPLAY DEVICE, DISPLAY METHOD, AND ON-BOARD DISPLAY DEVICE

(71) Applicants: CHENGDU BOE OPTOELECTRONICS TECHNOLOGY CO., LTD., Chengdu (CN); BOE TECHNOLOGY GROUP CO., LTD., Beijing (CN)

(72) Inventors: Cuicui LIANG, Beijing (CN); Bing ZHANG, Beijing (CN)

(21) Appl. No.: 16/510,536

(22) Filed: Jul. 12, 2019

(30) Foreign Application Priority Data
Jan. 15, 2019 (CN) 201910034086.2

(51) Int. Cl. G06F 1/16; G06F 3/14

(52) U.S. Cl. CPC G06F 1/1616; G06F 3/1446; G06F 1/1675

(57) ABSTRACT

This disclosure relates to a display device, a display method and a method of manufacturing the display device. The display device includes: a first display screen and a second display screen, wherein a plane where the first display screen is in and a plane where the second display screen is in form an angle in a range of 0-180 degrees; and an optical control structure disposed on a light emission side of the first display screen, for controlling a range of an angle of view of the first display screen.

### CROSS-REFERENCE TO RELATED APPLICATIONS

This application claims priority to Chinese Patent Application No. 201910034086.2, filed on Jan. 15, 2019, the disclosure of which is hereby incorporated by reference in its entirety into the present application.

### TECHNICAL FIELD

This disclosure relates to the technical field of display, and particularly to a display device, a display method and on-board display device.

### BACKGROUND

With the rapid development of the display technology, the display is widely used in more and more fields. On the one hand, the display is expected to have a wide angle of view, so that users at different angles of view can see the displayed content, that is, the display is in a wide viewing mode. On the other hand, in some scenarios, it is expected that the content displayed by the display is only intended for the user at a specific angle of view, but is not learned by users at other angles of view, that is, the display is in a narrow viewing mode.

In related art, the display is in the wide viewing mode at the time of normal display, but can realize the narrow viewing mode when an anti-peep film is attached.

### SUMMARY

According to some embodiments of this disclosure, a display device is provided, comprising: a first display screen and a second display screen, wherein a plane where the first display screen is in and a plane where the second display screen is in form an angle in a range of 0-180 degrees; and an optical control structure disposed on a light emission side of the first display screen, for controlling a range of an angle of view of the first display screen.

In some embodiments, the display device comprises a foldable display screen having a first display area and a second display area, which are formed by the first display screen and the second display respectively.

In some embodiments, the first display screen and the second display screen are connected via a shaft and rotatable about the shaft.

In some embodiments, the foldable display screen is an flexible display screen, which has a flexure zone, with the first display area and the second display area on opposites sides and disposed integrally with the first display area and the second display area.

In some embodiments, the light emission side of the first display screen is in the same direction as that of the second display screen in a case where the angle formed by the plane where the first display area is in and the plane where the second display area is in is 180 degree.

In some embodiments, the first display screen and the second display screen are juxtaposed one above the other, and wherein the second display screen is a transparent display screen.

In some embodiments, the optical control structure is located between the first display screen and the second display screen, and the light emission side of the first display screen is in the same direction as that of the second display screen.

In some embodiments, the first display screen comprises a plurality of first pixels separated by pixel-defined layer, the second display screen comprises a plurality of second pixels separated by a transparent zone, a position of the first pixels corresponds to that of the transparent zone, and a position of the second pixels corresponds to that of the pixel-defined layer.

In some embodiments, the optical control structure comprises: a plurality of columns separated by a light transmitting material layer, wherein a material of each column comprises a light absorption material, a position of the columns corresponds to that of the pixel-defined layer, and a position of the light transmitting material layer corresponds to that of the first pixels.

In some embodiments, the display device further comprising: a touch panel disposed on a light emission side of the second display screen.

In some embodiments, the optical control structure is formed integrally with the first display screen or the second display screen.

In some embodiments, the display device further comprises: a touch panel configured to operate with at least one of the first display screen or the second display screen.

In some embodiments, the display device further comprises: a first control circuit configured to control on or off of the first display screen; and a second control circuit configured to control on or off of the second display screen.

According to some other embodiments of this disclosure, a display method of a display device is provided. The display device comprising a first display screen and a second display screen, and an optical control structure disposed on a light emission side of the first display screen, for controlling a range of an angle of view of the first display screen. The display method comprising: in a first display mode, turning on a first display screen and turning off a second display screen; and in a second display mode, turning on the second display screen and turning off the first display screen.

In some embodiments, the display method further comprises: in a third display mode, turning on the first display screen and the second display screen.

In some embodiments, the display device comprises a foldable display screen having a first display area and a second display area, in which the first display screen and the second display screen are located respectively, and the display method further comprises: folding the foldable display screen, such that a plane where the first display screen is in and a plane where the second display screen is in form a specified angle.

According to some further embodiments of this disclosure, an on-board display device is provided, comprising: the display device according to any of the above embodiments.

In some embodiments, the display device is disposed on a central console position or a co-pilot position.

In some embodiments, the display device comprises a foldable display screen, of which the first display screen and the second display screen are located in different areas, a light emission side of the first display screen faces inside a vehicle, and a light emission side of the second display screen faces outside the vehicle.

The other features of this disclosure and their advantages will become clear through a detailed description of the exemplary embodiments of this disclosure with reference to the accompanying drawings below.

### BRIEF DESCRIPTION OF THE DRAWINGS

The accompanying drawings which constitute a part of the specification describe the embodiments of this disclosure, and together with the description, serve to explain the principle of this disclosure.

This disclosure can be understood more clearly with reference to the accompanying drawings according to the following detailed description, in which:

FIG. 1 is a schematic diagram showing a structure of a display device according to an embodiment of this disclosure;

FIG. 2A is a schematic diagram showing a structure of a display device according to another embodiment of this disclosure;

FIG. 2B is a top view of the optical control structure 130 in FIG. 2A;

FIG. 2C is a schematic diagram showing a structure of a display device according to a further embodiment of this disclosure;

FIGS. 3A and 3B are diagrams respectively showing effects of the first and second display modes according to some embodiments of this disclosure;

FIGS. 4A and 4B are schematic diagrams showing the use in the onboard field of a display device according to some embodiments of this disclosure;

FIGS. 5A and 5B are schematic diagrams showing a structure of a display device according to some embodiments of this disclosure;

FIGS. 6A and 6B are schematic diagram showing different effects of the third display mode according to some embodiments of this disclosure;

FIG. 7A is a flowchart showing a method of manufacturing a display device according to an embodiment of this disclosure;

FIG. 7B is a flowchart showing a method of manufacturing a display device according to another embodiment of this disclosure;

FIG. 8 is a flowchart showing a method of manufacturing an optical control structure according to an embodiment of this disclosure;

FIGS. 9A and 9B are sectional views respectively showing different formation phases of the optical control structure according to some embodiments of this disclosure.

It should be noted that, the dimensions of the parts shown in the accompanying drawings are not drawn in accordance with actual proportional relationships. In addition, identical or similar reference numerals represent identical or similar composite parts.

### DETAILED DESCRIPTION

The various exemplary embodiments of this disclosure are now described in detail with reference to the accompanying drawings. The description of the exemplary embodiment is merely illustrative and by no means serves as any restriction to this disclosure and its application or use. This disclosure can be implemented in many different forms and is not limited to the embodiments described here. These embodiments are provided in order to make this disclosure thorough and complete, and to fully express the scope of this disclosure to a person skilled in the art. It should be noted that, unless otherwise specified, the relative arrangements of the components and steps described in these embodiments should be interpreted as merely illustrative but not restrictive.

All terms (including technical terms or scientific terms) that are used in this disclosure have the same meanings as those understood by a person of ordinary skill in the field to which this disclosure pertains, unless otherwise specifically defined. It should also be understood that, terms defined in common dictionaries should be interpreted as having meanings consistent with their meanings in the context of the related technologies, rather than being interpreted in an idealized or extremely formalized sense, unless expressly defined here.

The technologies, methods and apparatuses known to those skilled in the related fields may not be discussed in detail, but where appropriate, the techniques, methods and apparatuses should be considered as part of the specification.

In the related art, the narrow viewing mode is realized by attaching an anti-peep film to the display. However, it is very inconvenient to switch between the wide viewing mode and the narrow viewing mode by means of an anti-peep film.

In view of this, this disclosure proposes a display device, which makes it convenient to switch between different display modes (e.g., the wide viewing mode and the narrow viewing mode).

According to some embodiments of this disclosure, a display device is provided, comprising: a first display screen and a second display screen, wherein a plane where the first display screen is in and a plane where the second display screen is in form an angle in a range of 0-180 degrees; and an optical control structure disposed on a light emission side of the first display screen, for controlling a range of the angle of view of the first display screen.

FIG. 1 is a schematic diagram showing a structure of a display device according to an embodiment of this disclosure.

FIG. 1 is a sectional view showing a display device according to an embodiment of this disclosure. As shown in FIG. 1, the display device comprises a first display screen 110, a second display screen 120 and an optical control structure 130.

The first display screen 110 and the second display screen 120 are discrete display screens, for example, two display screens that are juxtaposed one above the other. FIG. 1 shows that the second display screen 120 is located above the first display screen 110, for example, the second display screen 120 and the first display screen 110 are arranged in parallel. The optical control structure 130 is disposed on the light emission side of the first display screen 110, and is located between the first display screen 110 and the second display screen 120. In other words, the second display screen 120 is located on a side of the optical control structure 130 away from the first display screen 110.

In some embodiments, the second display screen 120 is a transparent display screen, e.g., an OLED (Organic Light-Emitting Diode) display screen. The first display screen 110 can also adopt an OLED display screen. Of course, the first display screen 110 and the second display screen 120 can also adopt other types of display screen, such as LCD (Liquid Crystal Display), QLED (Quantum dot Light Diode Quantum Dot Light) display screen, etc. It should be understood that the first display screen 110 and the second display screen 120 can also adopt different types of display screen, for example, the first display screen 110 is a LCD display screen while the second display screen 120 is an OLED display screen.

In the wide viewing mode, the first display screen 110 is turned off and the second display screen 120 is turned on. In the wide viewing mode, the range of the angle of view is decided by the second display screen 120 located above. Since the optical control structure is not provided above the second display screen 120, it is in a normal wide viewing display state, then the wide viewing mode can be achieved. In the narrow viewing mode, the first display screen 110 is turned on and the second display screen 120 is turned off. In the narrow viewing mode, since the second display screen 120 disposed above is a transparent display screen, the range of the angle of view is decided by the first display screen 110 and the optical control structure 130 disposed below.

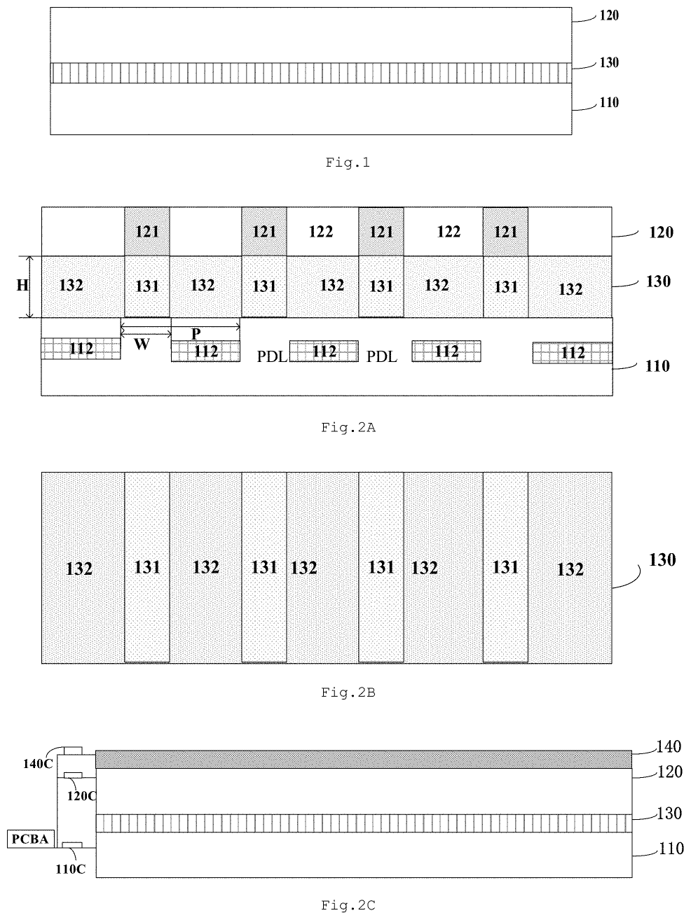

FIG. 2A is a schematic diagram showing a structure of the display device according to another embodiment of this disclosure. FIG. 2A differs from FIG. 1 in that, it shows specific structures of the second display screen 120, the first display screen 110, and the optical control structure 130, and position relations therebetween. The following will describe only the differences between FIG. 2A and FIG. 1, and the similarities therebetween are not repeated.

The second display screen 120 is a transparent display screen, e.g., OLED transparent display screen. As shown in FIG. 2A, the second display screen 120 comprises a plurality of pixels 121 separated by a transparent zone 122. The first display screen 110 comprises a plurality of pixels 112 separated by a pixel-defined layer PDL. In some embodiments, the display screens 111 and 121 both comprise pixels R, G, B separated by the pixel-defined layer.

As shown in FIG. 2A, the position of the pixels 112 in the first display screen correspond to the position of the transparent zone 122 in the second display screen, and the position of the pixels 121 in the second display screen correspond to the position of the pixel-defined layer. The position correspondence can be understood as that orthographic projections of the elements on the light emission surface partially overlap.

As shown in FIG. 2A, the optical control structure 130 comprises a plurality of columns 131. In some embodiments, a pitch P between the plurality of columns 131 is in a range of 30 μm-60 μm. A height H of each column 131 is in a range of 20 μm-50 μm. A column 131 has a cuboid shape, of which the cross section is rectangular. A length of the rectangle corresponds to the height H, and a width w of the rectangle can be less than or equal to the height H. Of course, the cross section of the column 131 can be trapezoid.

A material of each column 131 may include a light absorption material 131. In some embodiments, the light absorption material 131 includes a black color resistance material, such as black resin, also known as black matrix (BM). In other embodiments, the light absorption material 131 includes a metal of Cr, or polypropylene resin doped with a black material such as C, or photoresist doped with a material such as C, Ti and Ni.

As shown in FIG. 2A, the plurality of columns 131 are separated by a light transmitting material layer 132. The light transmitting material 132 may include a transparent color resistance material, such as Optical Clear Adhesive (OC) material.

As shown in FIG. 2A, the optical control structure 130 is formed above the first display screen 110. In some embodiments, the position of the light transmitting material layer 132 corresponds to the position of each pixel 112 in the first display screen 110, and corresponds to the position of the transparent zone 122 in the second display screen 120. In the narrow viewing mode, the range of the angle of view is decided by the displaying of the pixels 112 in the first display screen 110 corresponding to the light transmitting material layer 132.

FIG. 2B is a top view of the optical control structure 130 in FIG. 2A.

As shown in FIG. 2B, the columns 131 and the light transmitting material layer 132 are both rectangular. That is to say, each column 131 is a continuous strip, rather than discrete strips, in a direction perpendicular to the page of FIG. 2A.

FIG. 2C is a schematic diagram showing a structure of the display device according to a further embodiment of this disclosure. FIG. 2C differs from FIG. 1 in further comprising components operating with the first display screen 110 and the second display screen 120. The following will describe only the differences between FIG. 2C and FIG. 1, and the similarities therebetween are not repeated.

In some embodiments, the display device further comprises a first control circuit 110C and a second control circuit 120C, as shown in FIG. 2C.

The first control circuit 110C is configured to control the on or off of the first display screen 110. In some embodiments, the first control circuit 110C adopts COF (Chip on Film). The second control circuit 120C is configured to control the on or off of the second display screen 120. The second control circuit 120C can also adopt COF similar to the first control circuit 110C.

In some other embodiments, the display device further comprises a touch panel 140. As shown in FIG. 2C, the touch panel 140 is disposed above the second display screen 120, i.e. on a side of the second display screen 120 away from the optical control structure 130. The touch panel 140 is configured to work with at least one of the first display screen 110 and the second display screen 120. For example, in the wide viewing mode, the first display screen 110 is turned off, the second display screen 120 is turned on, and the touch panel 140 operates with the second display screen 120. In the narrow viewing mode, the first display screen 110 is turned off, the second display screen 120 is turned on, and the touch panel 140 operates with the first display screen 110.

FIG. 2C further shows a control circuit 140C of the touch panel 140. In some embodiments, the control circuit 140C adopts a FPC (Flexible Printed Circuit). FPC and COF may collectively form a PCBA (Printed Circuit Board Assembly) of the display device, for controlling the operation of the display device.

In the above embodiments, through the arrangement of the first display screen and the optical control structure and the second display screen, by controlling the first display screen and the second display screen to be in different switching states (e.g. on or off) in different display modes, the switching between the first display mode (e.g. narrow viewing mode) and the second display mode (e.g. wide viewing mode) can be conveniently realized.

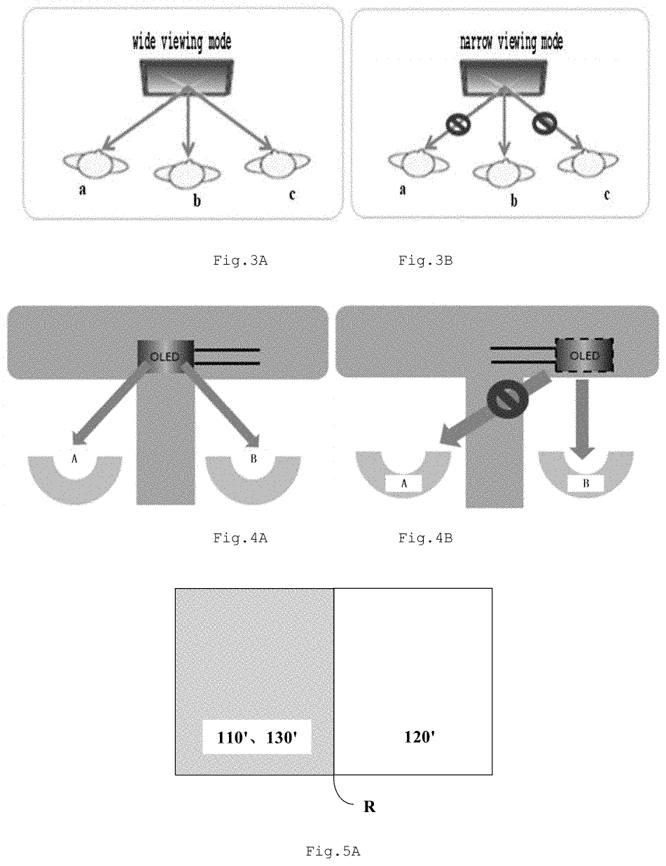

FIGS. 3A and 3B are diagrams respectively showing effects of the first and second display modes according to some embodiments of this disclosure.

FIG. 3A shows an effect of the wide viewing mode. As shown in FIG. 3A, users at different angles of view such as a, b, and c can view what is displayed on the display device.

FIG. 3B shows an effect of the narrow viewing mode. As shown in FIG. 3B, users at only the angle b can view what is displayed on the display device, while users at other angles such as a and c cannot view what is displayed on the display device.

The display device according to the embodiments of this disclosure may be applied to the on-board field. With the rapid development of on-board applications, it is expected that the on-board display device can conveniently switch between the wide viewing mode and the narrow viewing mode according to actual needs.

FIGS. 4A and 4B are schematic diagrams respectively showing the use in the on-board field of the display device according to some embodiments of this disclosure.

The display device (e.g., OLED display screen) can be set as movable, e.g. mounted on a movable bracket, such that it can move between the central console position and the co-pilot position.

FIG. 4A is a schematic diagram showing the use in the wide viewing mode. As shown in FIG. 4A, the display device is located in the central console position between a main driver position A and a co-pilot position B. In the wide viewing mode, users in the main driver position A and the co-pilot position B can simultaneously view what is displayed on the display device, e.g., driving information.

FIG. 4B is a schematic diagram showing the use in the narrow viewing mode. As shown in FIG. 4B, the display device is located in the co-pilot position. In the narrow viewing mode, only the user in the co-pilot position B can view what is displayed on the display device, while the driver in the main driver position A cannot view what is displayed on the display device. In the narrow viewing mode, the display device is only available to the user in the co-pilot position to view for example entertainment content, without affecting the driver's safe driving, thus taking into account both demands on safe driving and entertainment.

It should be understood that, the display device according to the embodiments of this disclosure can be applied to other fields. For example, the display devices can be applied to mobile phones, tablet computers, televisions, laptop computers, digital photo frames, navigators and any other product or component with the display function.

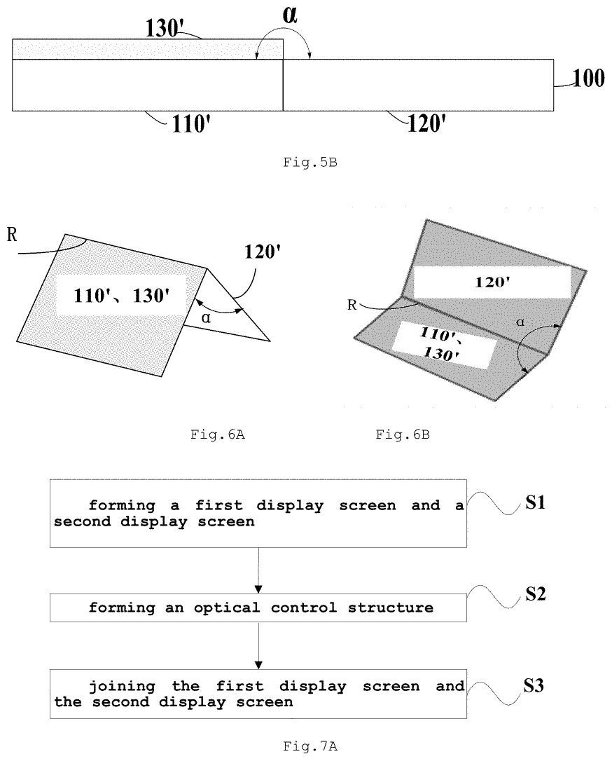

FIGS. 5A and 5B are schematic diagrams showing a structure of the display device according to some embodiments of this disclosure.

As shown in FIGS. 5A and 5B, the display device further comprises a first display screen 110′, a second display screen 120′ and an optical control structure 130′. FIGS. 5A and 5B differ from FIG. 1 only in that, the first display screen 110′ and the second display screen 120′ can rotate around a shaft R.

As shown in FIG. 5A, the display device comprises two display screens that can rotate about the same shaft R, i.e. the first display screen 110′ and the second display screen 120′. The first display screen 110′ and the second display screen 120′ in FIGS. 5A and 5B can be integrated or discrete display screens. In case where the first display screen 110′ and the second display screen 120′ are integrated, the first display screen 110′ and the second display screen 120 can rotate along shafts in different directions as needed. That is, the shaft R is not fixed, but is virtual. In some embodiments, the second display screen 120′ is a transparent display screen.

The case where the first display screen 110′ and the second display screen 120′ are integrated is described below as an example. The first display screen 110′ and the second display screen 120′ are located in different areas of the same foldable display screen 100. For example, the same foldable display screen 100 having a first display area and a second display area, which are formed by the first display screen and the second display respectively. In some embodiments, the foldable display screen 100 is a flexible display screen, for example an OLED display screen. The foldable display screen 100 can achieve a folding range of 360 degrees, i.e. the plane where the first display screen 110′ is in and the plane where the second display screen 120′ is in form an angle a in the range of 0-180 degrees.

FIGS. 5A and 5B show that the plane where the first display screen 110′ is in and the plane where the second display screen 120′ is in form an angle a of 180 degrees. The optical control structure 130′ is disposed on the light emission side of the first display screen 110′. As shown in FIG. 5B, the optical control structure 130′ is located above the first display screen 110′. The light emission side of the first display screen 110′is in the same direction as that of the second display screen 120′.

As mentioned earlier, a touch panel may be further provided to operate with at least one of the first display screen 110′ or the second display screen 120′. In some embodiments, the optical control structure 130′ can be implemented in a similar manner to the optical control structure 130.

Similar to the preceding embodiments, the switching state of the first display screen 110′ and the second display screen 120′ can be controlled by a corresponding control circuit, thus enabling the switching between different display modes. For example, in the first display mode (e.g. narrow viewing mode), the second display screen 120′ is turned off, the first display screen 110′ is turned on, and the range of the angle of view is decided by the first display screen 110′ and the optical control structure 130′. In the second display mode (e.g. wide viewing mode), the first display screen 110′ is turned off and the second display screen 120′ is turned on. Since the optical control structure is not provided above the second display screen 120′, it is in a normal wide viewing display state, then the wide viewing mode can be realized.

Unlike the preceding embodiments, the display devices shown in FIGS. 5A and 5B can also realize a third display mode, that is, the wide viewing mode and the narrow viewing mode are used simultaneously. In the third display mode, both the first display screen 110′ and the second display screen 120′ are turned on. By folding the foldable display screen 100, the plane where the first display screen 110′ is in and the plane where the second display screen 120′ is in form an angle in the range of 0-180 degrees. In this way, different display screens work at the same time, such that both the wide viewing mode and the narrow viewing mode are used simultaneously.

FIGS. 6A and 6B show different effects of the third display mode according to some embodiments of this disclosure.

As shown in FIG. 6A, the foldable display screen 100 can be folded about the shaft R by 270 degrees, such that the plane where the first display screen 110′ is in and the plane where the second display screen 120′ is in form an angle of 90 degrees. The first display screen 110′ is only available to users at a specific range of angle of view, while the second display screen 120′ is available to multiple users at different ranges of angle of view.

As shown in FIG. 6B, the foldable display 100 can also be folded about the shaft R by 100 degrees. One display screen can serve as content display and another display screen can serve as keyboard display to meet operational needs. In case where multiple users need to view the display, the second display screen 120′ in the wide viewing mode can serve as content display, while the first display screen 110′ in the narrow viewing mode serves as keyboard display. In the case of display for specific users only, the first display screen 110′ in the narrow viewing mode can serve as content display, while the second display screen 120′ in the wide viewing mode can serve as keyboard display.

In the above embodiments, the display device is foldable and different display screens can rotate about the shaft. This allows to select different folding angles based on actual needs. In addition, when not in use, the first display screen and the second display screen can be folded, thus reducing a space occupied by the display device.

The foldable display device can be also used in the on-board field. In some embodiments, the foldable display device in the state shown in FIG. 6A is placed in the co-pilot position, the wide-angled display screen is facing the front glass of the vehicle for the person outside the vehicle to watch, and the narrow-angled display screen is facing the co-pilot for the co-pilot to watch. For example, the wide-angle display screen displays vehicle occupancy, advertising information, and so on, while the narrow-view display screen displays entertainment information, and so on.

According to the embodiments of this disclosure, a method of manufacturing the display device is also provided, comprising: forming a first display screen and a second display screen, and forming an optical control structure on a light emission side of the first display screen.

FIG. 7A is a flowchart showing a method of manufacturing a display device according to an embodiment of this disclosure. As shown in FIG. 7A, the method of manufacturing the display device comprises step S1-S3.

In the step S1, a first display screen and a second display screen, for example, form the first display screen 110 and the second display screen 120 as shown in FIG. 1, are formed.

As mentioned earlier, the first display screen and the second display screen both can adopt the same type of display screen, or different types of display screen, as long as the second display screen is a transparent display screen. For example, both the first display screen and the second display screen adopt the OLED display screen; or the first display screen adopts a LCD display screen, while the second display screen adopts an OLED display screen.

It should be understood that the order of forming the first display screen and forming the second display screen in step S1 is independent of each other, for example, the formation can be synchronized or not.

In the step S2, an optical control structure is formed. The optical control structure may have the structure 130 as shown in FIG. 2A. In some embodiments, the optical control structure is formed on an upper surface (e.g. above the cover plate, if any) of the first display screen. For example, the optical control structure can be formed integrally with the first display screen. In some other embodiments, the optical control structure is formed on a lower surface(e.g. the substrate) of the second display screen. For example, the optical control structure can also be formed integrally with the second display screen.

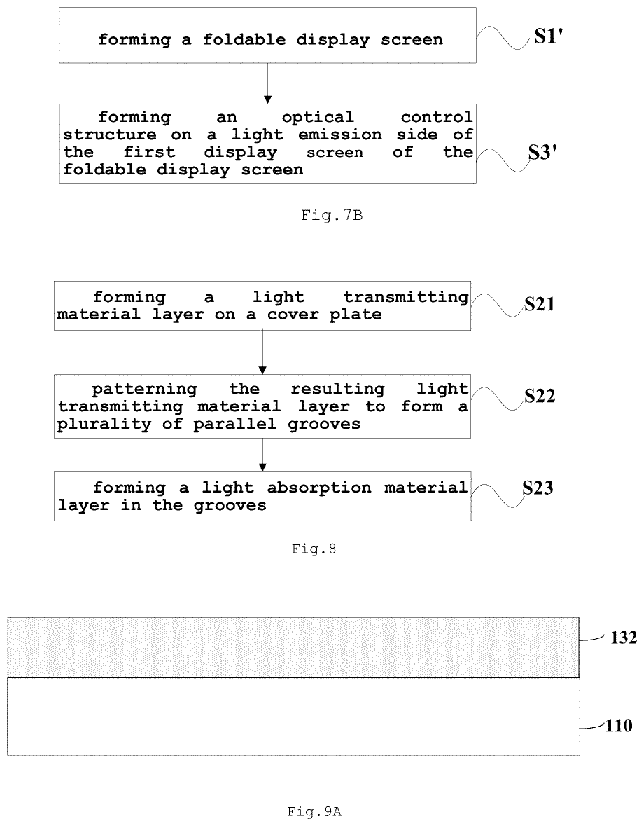

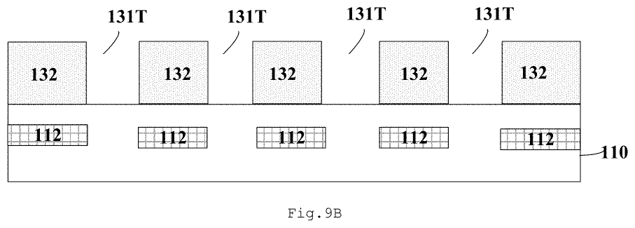

FIG. 8 shows a flowchart of the method of manufacturing the optical control structure according to an embodiment of this disclosure. FIGS. 9A and 9B are sectional views respectively showing different formation stages of the optical control structure according to some embodiments of this disclosure. The method of manufacturing the optical control structure is described below in combination with FIGS. 8, 9A, 9B and 2A.

As shown in FIG. 8, in case where the optical control structure is formed above the first display screen, the manufacturing method comprises steps S21-S23.

In the step S21, a light transmitting material layer 132 above the first display screen 110 is formed, resulting in a structure as shown in FIG. 9A, for example. In some embodiments, an optical adhesive used as a light-transmitting material is applied to the first display screen and then a curing process is performed to form the light-transmitting material. The curing process can be achieved by a UV light.

In the step S22, the resulting light transmitting material layer 132 is patterned to form a plurality of parallel grooves 131T, resulting in a structure as shown in FIG. 9B, for example. As shown in FIG. 9B, the light transmitting material layer 132 is patterned to retain only areas corresponding to each pixel 112 of the first display screen 110. For example, the patterning can be made by using a mask through a lithography process such as exposure and development.

In the step S23, a light absorption material layer is filled in the groove 131T to form the optical control structure 130 comprising a plurality of columns 131 as shown in FIG. 2A. In some embodiments, a black resin used as a light absorption material is poured in the groove first, and then a curing process is performed to form the light absorption material layer. The curing process can also be achieved by UV light.

Go back to FIG. 7A to continue describing the step S3. In the step S3, the first display screen and the second display screen are joined.

In some embodiments, the first display screen and the second display screen are joined, so that the optical control structure is located between the first display screen and the second display screen, that is, the optical control structure is located on the light emission side of the first display screen, resulting in the structure shown in FIG. 2A. For example, the first display screen and the second display screen can be adhered to each other by an optical adhesive.

In some other embodiments, the first display screen and the second display screen are joined by a shaft, i.e. forming the structure shown in FIG. 5A.

FIG. 7B is a flowchart showing the method of manufacturing the display device according to another embodiment of this disclosure. As shown in FIG. 7B, the method of manufacturing the display device comprises step S1′-S3′.

In the step S1′, a foldable display screen is formed. In some embodiments, the foldable display screen comprises two display screens that can be rotate about the same shaft. That is, the different display areas of the foldable display screen are formed respectively by the first display screen and the second display screen, for example the first display screen 110′ and the second display screen 120′ as shown in FIG. 5B.

In the step S3′, an optical control structure on the light emission side of the first display screen of the foldable display screen is formed, resulting in the optical control structure 130′ shown in FIG. 5B, for example. In some embodiments, the optical control structure 130′ can be formed using a similar process to the optical control structure 130.

The structure as shown in FIG. 5B can be formed through the step S1′ and S3′.

So far, the various embodiments of this disclosure have been described in detail. In order to avoid shielding the idea of this disclosure, some of the details well known in the art are not described. Those skilled in the art can fully understand how to carry out the technical solutions disclosed herein according to the above description.

Although some specific embodiments of this disclosure have been described in detail by way of examples, those skilled in the art should understand that the above examples are for illustrative purposes only, but not for limiting the scope of this disclosure. Those skilled in the art should understand that the above embodiments can be modified or some technical features can be equivalently replaced without departing from the scope and spirit of this disclosure. The scope of this disclosure is limited by the attached claims.

What is claimed is:

1. A display device, comprising:
a first display screen and a second display screen, wherein a plane where the first display screen is in and a plane where the second display screen is in form an angle in a range of 0-180 degrees; and
an optical control structure disposed on a light emission side of the first display screen, for controlling a range of an angle of view of the first display screen.

2. The display device according to claim 1, wherein the display device comprises a foldable display screen having a first display area and a second display area, which are formed by the first display screen and the second display screen respectively.

3. The display device according to claim 2, wherein the first display screen and the second display screen are connected via a shaft and rotatable about the shaft.

4. The display device according to claim 2, wherein the foldable display screen is an flexible display screen, which has a flexure zone, with the first display area and the second display area on opposites sides and disposed integrally with the first display area and the second display area.

5. The display device according to claim 2, wherein the light emission side of the first display screen is in the same direction as that of the second display screen in a case where the angle formed by the plane where the first display area is in and the plane where the second display area is in is 180 degree.

6. The display device according to claim 1, wherein the first display screen and the second display screen are juxtaposed one above the other, and wherein the second display screen is a transparent display screen.

7. The display device according to claim 6, wherein the optical control structure is located between the first display screen and the second display screen, and the light emission side of the first display screen is in the same direction as a light emission side of the second display screen.

8. The display device according to claim 7, wherein the first display screen comprises a plurality of first pixels separated by pixel-defined layer, the second display screen comprises a plurality of second pixels separated by a transparent zone, a position of the plurality of first pixels corresponds to that of the transparent zone, and a position of the plurality of second pixels corresponds to that of the pixel-defined layer.

9. The display device according to claim 8, wherein the optical control structure comprises:
a plurality of columns separated by a light transmitting material layer, wherein a material of each column comprises a light absorption material, a position of the plurality of columns corresponds to that of the pixel-defined layer, and a position of the light transmitting material layer corresponds to that of the plurality of first pixels.

10. The display device according to claim 9, further comprising: a touch panel disposed on the light emission side of the second display screen.

11. The display device according to claim 6, wherein the optical control structure is formed integrally with the first display screen or the second display screen.

12. The display device according to claim 1, further comprising: a touch panel configured to operate with at least one of the first display screen or the second display screen.

13. The display device according to claim 1, further comprising:
a first control circuit configured to control on or off of the first display screen; and
a second control circuit configured to control on or off of the second display screen.

14. A display method of a display device, the display device comprising a first display screen and a second display screen, and an optical control structure disposed on a light emission side of the first display screen, for controlling a range of an angle of view of the first display screen, the display method comprising:
in a first display mode, turning on the first display screen and turning off the second display screen; and
in a second display mode, turning on the second display screen and turning off the first display screen.

15. The display method according to claim 14, further comprising: in a third display mode, turning on the first display screen and the second display screen.

16. The display method according to claim 14, wherein the display device comprises a foldable display screen having a first display area and a second display area, in which the first display screen and the second display screen are located respectively, and the display method further comprises:
folding the foldable display screen, such that a plane where the first display screen is in and a plane where the second display screen is in form a specified angle.

17. An on-board display device comprising: the display device according to claim 1.

18. The on-board display device according to claim 17, wherein the display device is disposed on a central console position or a co-pilot position.

19. The on-board display device according to claim 17, wherein the display device comprises a foldable display screen, of which the first display screen and the second display screen are located in different areas, the light emission side of the first display screen faces inside a vehicle, and a light emission side of the second display screen faces outside the vehicle.
